(19) United States
(12) Patent Application Publication
(10) Pub. No.: US 2005/0168227 A1
(43) Pub. Date: Aug. 4, 2005

(54) Battery conditioning apparatus

(76) Inventor: Ross Naddei, Eatons Hill (AU)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/522,938

(22) PCT Filed: Jul. 29, 2003
(86) PCT No.: PCT/AU03/00957

(30) Foreign Application Priority Data
Aug. 1, 2002 (AU) 2002950518

(51) Int. Cl. G01N 27/416

(52) U.S. Cl. 324/433

(57) ABSTRACT

An apparatus for lowering internal battery resistance, comprising a pulse generator for delivering pulses to at least one terminal of the battery and a controller for controlling the pulse generator and comprising a voltage input selector for selecting the voltage at which the controller is operated.

### FIELD OF THE INVENTION

This invention generally relates to a battery conditioning apparatus. In particular, the invention relates to a battery conditioning apparatus that is operable to substantially prevent or reverse the accumulation of lead sulphate on the electrodes of a lead-acid battery.

Although the invention will be described with reference to 12 volt and 24 volt wet cell lead-acid batteries, it will be appreciated that this is by way of example only and that the invention may be used with other types of lead-acid-batteries.

### BRIEF DESCRIPTION OF THE PRIOR ART

Lead-acid batteries such as those commonly used in motor vehicles usually include a plurality of electrically interconnected cells. Each cell includes two plates that are referred to as electrodes. Typically, one of the electrodes is constructed from lead peroxide while the other electrode is constructed from spongy lead. The electrodes are immersed in an electrolyte which, in the case of wet cell lead-acid batteries, is usually provided by dilute sulphuric acid.

When the cells of the battery are functioning normally, the acid reacts with the electrodes, converting chemical energy into electrical energy so that a positive charge is built-up on the lead peroxide electrode and a negative charge on the other electrode. The charges on the different electrodes result in a potential difference or voltage being produced between the electrodes. The cells are usually constructed so that they each produce a particular voltage and are interconnected so as to produce a desired voltage (e.g. 12 V or 24 V) at the terminals of the battery.

As the chemical reaction between the electrodes and the acid continues, lead sulphate forms on the surface of the electrodes, and the sulphuric acid is converted to water. When the surfaces of both electrodes are completely coated with lead sulphate, the battery is flat.

Recharging the cell with an electric current restores the electrodes to their original condition and regenerates the sulphuric acid.

Battery conditioning apparatus have been developed which are able to prevent or reverse the accumulation of lead sulphate on the electrodes of a lead-acid battery. These apparatus produce electrical pulses that are applied to the terminals of the battery when the terminal voltage of the battery increases above a threshold value. When applied to the battery terminals, the electrical pulses prevent or reverse the accumulation of lead sulphate on the battery electrodes. It has been found that such battery conditioning apparatus can significantly increase the operating life and efficiency of batteries.

It has been found that battery conditioning apparatus of the aforementioned type are somewhat inefficient in regards to the proportion of generated electrical pulse energy that they are able output to a battery. Further, they do not allow for easy adjustment of the threshold voltage. Moreover, they do not provide any sort of indication as to the amplitude of the electrical pulses applied to the battery.

It is an object of the present invention to overcome, or at least substantially ameliorate, one or more of the deficiencies of the prior art.

Other objects and advantages of the present invention will become apparent from the following description, taken in connection with the accompanying drawing, wherein, by way of illustration and example, an embodiment of the present invention is disclosed.

### SUMMARY OF THE INVENTION

According to one aspect of the present invention there is provided an apparatus for lowering internal battery resistance, comprising a pulse generator for delivering pulses to at least one terminal of the battery and a controller for controlling the pulse generator and comprising a voltage input selector for selecting the voltage at which the controller is operated.

Preferably the voltage input selector comprises at least two threshold voltages at which the controller operates.

Preferably the voltage input selector comprises a high voltage threshold and a low voltage threshold.

The voltage input selector preferably comprises a switch coupled to a voltage divider.

The controller may have an input connected to the output of the pulse generator.

Preferably the controller has an output connected to an input stage of the pulse generator.

It is preferred that the controller includes a comparator for comparing the threshold voltage of the voltage input selector with a reference voltage.

Preferably the reference voltage is derived from the battery.

Preferably the comparator outputs a signal to the output if the threshold voltage is above the reference voltage.

Preferably the pulse generator comprises an input stage including a wave generator for generating a wave having a predetermined frequency and wave width.

Preferably the wave generator comprises a square wave generator.

The pulse generator preferably includes an input switch controlled by the controller.

The pulse generator preferably includes an inverter connected to an output switch of the pulse generator.

The wave generator may include a pulse width control means and a frequency control means.

The output switch preferably comprises a transistor.

It is preferred that the controller varies amplitude of pulses delivered to the battery in accordance with the internal resistance of the battery.

It is preferred that the apparatus includes an electronic circuit for indicating a battery condition such as its internal resistance.

According to another aspect of the present invention there is provided an electronic circuit for indicating a battery condition, comprising an indicator means, a first input for connection to a battery, a second input for connection to an output of a controller of a pulse generator wherein the indicator means provides an indication of the voltage of a pulse applied to the battery.

It is preferred that the indicator means provides an indication that the voltage of a pulse applied to a battery has one of a plurality of possible amplitudes.

It is preferred that the indicator means includes at least two different indicators.

Preferably the indicator means comprises three different indicators.

The indicator means may consist of any one or more of light emitting devices such as LED's, or laser diodes, or LCD devices, metering devices and any other type of visual indicator or audible indicator such as a speaker and associated sound producing circuitry.

It is preferred that the electronic circuit comprises a plurality of operational amplifiers each having a different coloured LED connected to its output.

Preferably one input of each operational amplifier is connected to a reference voltage source.

According to one embodiment the output of each operational amplifier is connected through its associated LED to one terminal of the battery.

It is preferred that each LED provides a different resistance so that it is switched on when a predetermined voltage is applied across.

It is preferred that the input of one of the operational amplifiers is connected to one of the terminals of the battery.

It is preferred that one of inputs of one of the operational amplifiers is connected to an output stage of the voltage selector of a controller for a pulse generator.

According to another aspect of the present invention there is provided an apparatus for reversing the accumulation of lead sulphate on an electrode of a lead acid battery which has any one of the features of the apparatus for lowering internal battery resistance.

According to another aspect of the present invention there is provided an apparatus for lowering battery internal resistance, comprising a wave generator, a filter circuit, a switch and an inductor means wherein the switch is configured to be switched on in accordance with the signal generated by the wave generator and in combination with the inductor means is configured to generate a periodic pulse which can be applied to a terminal of a battery, whereby the internal resistance of the battery is lowered.

Preferably the inductor means is connected to an output of the switch and to an output of the filter.

Preferably both the switch and inductor means are connected to one terminal of the battery.

Preferably the inductor means and switch are connected to a polyswitch which is connected to the battery terminal.

It is preferred that the switch includes a first input which is configured to receive a switch-on signal from a controller.

Preferably the switch includes an inverter for inverting the signal produced by the wave generator.

Preferably the wave generator is a square wave generator.

The square wave generator preferably includes a frequency controller and/a pulse width controller.

The frequency controller and/or pulse width controller preferably comprise potentiometers.

It is preferred that the switch includes a transistor with its base connected to an output of the inverter.

It is preferred that an emitter or source of a transistor is connected to a negative terminal of the battery.

Preferably a collector or drain of the transistor is connected to the inductor means.

Preferably the drain or collector of the transistor is connected to the polyswitch.

According to another aspect of the present invention there is provided a battery conditioning apparatus for preventing or reversing the accumulation of lead sulphate on an electrode of a lead-acid battery, the apparatus including an electrical pulse generator adapted to be coupled to the battery, the pulse generator including a switch, an inductor coupled to the switch, and a capacitor coupled to the inductor, wherein, in use, the switch is operated such that the inductor generates electrical pulses, and the inductor is directly coupled to the battery such that the electrical pulses are applied to the electrode.

According to a further aspect of the present invention there is provided a battery conditioning apparatus for preventing or reversing the accumulation of lead sulphate on an electrode of a lead-acid battery, the apparatus including an electrical pulse generator adapted to be coupled to the battery, and a controller operable to enable and disable the pulse generator when the battery voltage is respectively above and below a threshold voltage, wherein the threshold voltage is selectively adjustable by a user.

According to an additional aspect of the present invention there is provided a battery conditioning apparatus for preventing or reversing the accumulation of lead sulphate on an electrode of a lead-acid battery, the apparatus including an electrical pulse generator adapted to be coupled to the battery, and a pulse amplitude indicator operable to indicate the amplitude of the pulses.

### BRIEF DESCRIPTION OF THE DRAWINGS

In order that the invention may be more fully understood and put into practice, a preferred embodiment thereof will now be described with reference to the accompanying drawing, in which

FIG. 1 is a schematic circuit diagram of a battery conditioning apparatus according to a preferred embodiment of the present invention.

### DETAILED DESCRIPTION OF THE PREFERRED EMBODIMENT

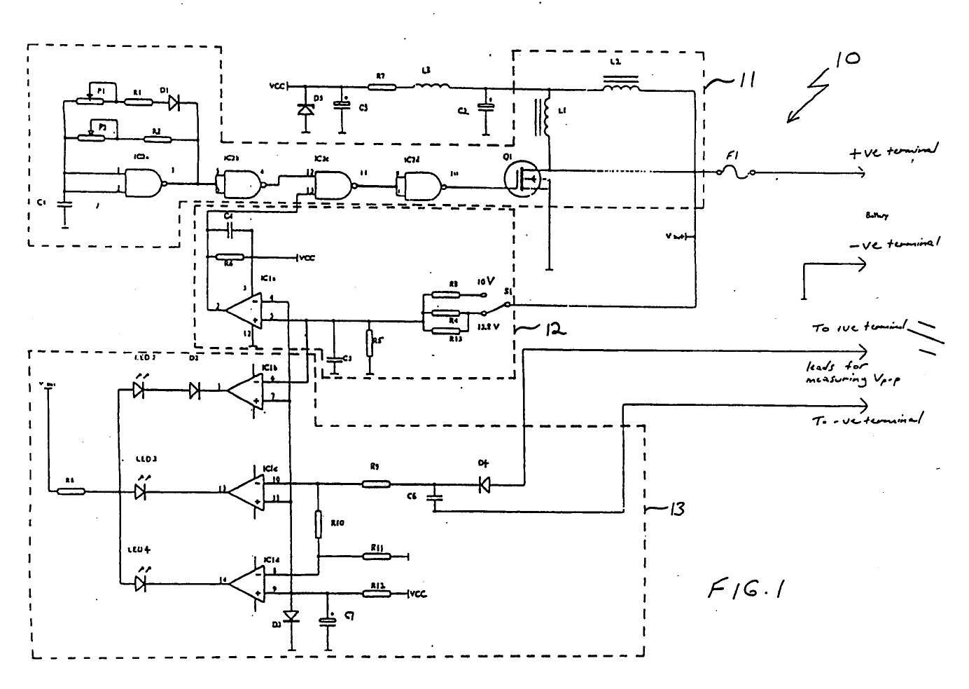

Referring to FIG. 1, a battery conditioning apparatus 10 for reversing sulphation on the electrodes of a 12 V lead-acid battery (not shown) includes a pulse generator 11, a controller 12 and a pulse amplitude indicator 13. The apparatus 10 is operable to prevent or reverse the accumulation of lead sulphate on the electrodes of a lead-acid battery by applying a series of electrical pulses across the terminals of the battery. The amplitude of the pulses applied across the battery terminals by the apparatus 10 is proportional to the amount of sulphate on the electrodes of the battery.

The apparatus 10 is coupled across the +ve and −ve terminals of the battery such that the +ve battery terminal is coupled to the apparatus 10 via a 0.4 A/60 V polyswitch F1 that serves as a fuse. Power for the apparatus 10 is derived from the battery such that the supply voltage Vcc is held to a constant 10 V by a 10V zener diode D5. The zener diode D5 is coupled to a power supply filter including a 220 μf capacitor C2, 470 μh inductor L3, 560 Ω resistor R7 and 0.1 μf capacitor C3. The power supply filter is coupled to the polyswitch F1 via parallel connected 3 A toroid inductors L1 (100 μh and L2 (4-10 μh Inductors L1 and L2 are directly coupled to the +ve battery terminal via the polyswitch F1.

The pulse generator 11 is operable to generate the electrical pulses that are applied across the +ve and −ve terminals of the battery by the apparatus 10. The pulse generator 11 includes a square wave generator that is provided by a Schmitt trigger NAND logic gate IC2a and additional circuitry associated therewith. The additional circuitry includes a 2.2 nF capacitor C1 that is coupled to the inputs of NAND gate IC2a. Further, a 1 MΩ potentiometer P2 and a 560 kΩ resistor R2 are connected in series between the inputs and output of the NAND gate IC2a. A 2 kΩ potentiometer P1, 470 Ω resistor R1 and a IN4148 diode D1 are also connected in series between the inputs and output of the NAND gate IC2a such that they are connected in parallel with respect to potentiometer P2 and resistor R2. The square wave generator generates a 1 kHz square wave having a duty cycle of approximately 99.8% due to the different charging and discharging paths of the capacitor C1. The aforementioned frequency and duty cycle values mean that the generated square wave is low for approximately 2 μs and high for approximately 0.998 ms of each cycle.

The potentiometer P1 controls the width of the generated square wave and thus the width of the pulse. This corresponds to the current consumption of the circuit. Potentiometer P2 controls the frequency of the generated square wave and thus the frequency of the pulse and thus gives an indication of the repetition rate.

The square wave signal produced by the wave generator is input into both inputs of a second NAND gate IC2b so that NAND gate IC2b functions as an inverter. The inverted square wave signal produced by NAND gate IC2b is then input into one of the inputs of a third NAND gate IC2c. The other input of NAND gate IC2c is coupled to the output of the controller 12 which is operable to enable and disable the pulse generator. The output of NAND gate IC2c is coupled to both inputs of a fourth NAND gate IC2d so that NAND gate IC2d functions as an inverter. Thus, assuming that the pulse generator 11 is enabled by the controller 12, the signal produced at the output of NAND gate IC2d will be an inverted version of the square wave generated by the square wave generator. The square wave signal at the output of NAND gate IC2d will therefore have a frequency of 1 kHz and a duty cycle of approximately 0.2% which means that the square wave will be low for approximately 0.998 ms and high for approximately 2 μs of each cycle. The output of NAND gate IC2d is coupled to the gate of a MOSFET transistor Q1 that functions as a switch. Transistor Q1 may, for example, be an IRF 540 or IRF 530 transistor. The drain of transistor Q1 is coupled to the previously described power supply filter through parallel connected inductors L1 and L2. In addition, the drain of transistor Q1 is coupled to the +ve battery terminal via polyswitch F1. The source of transistor Q1 is coupled to the −ve battery terminal.

If the pulse generator 11 is enabled so that the inverted version of the square wave generated by the square wave generator appears at the output of NAND gate IC2d, the transistor 01 will be switched ON and OFF in an alternating manner as the voltage at the gate of the transistor Q1 varies between the high and low states. When transistor Q1 is switched ON, an effective short circuit is created between the drain and source of the transistor Q1 so that current is able to flow between the +ve and −ve battery terminals through the polyswitch F1, inductors L1, L2 and transistor Q1. The maximum current that flows between the +ve and −ve battery terminals when the transistor Q1 is switched ON is mainly dependent upon the impedance of the polyswitch F1. When transistor Q1 is switched OFF, an effective open circuit is created between the drain and source of the transistor Q1 so that current is unable to flow between the +ve and −ve battery terminals through the transistor Q1. The creation of this open circuit results in the magnetic energy stored in the inductors L1 and L2 being converted into a relatively high voltage electrical pulse which is output to the +ve battery terminal. The duration of each pulse is approximately 100 to 200 ns and the energy of each pulse can be estimated as the total inductance provided by inductors L1 and L2 multiplied by the rate of change of current therethrough. The amplitude of the electrical pulse is dependent upon the amount of sulphate on the battery electrodes. If only a small amount of sulphate is present on the electrodes the amplitude of the pulse will be relatively low. If a large amount of sulphate is present on the electrodes the amplitude of the pulse may be as high as 64V.

The reason for this is that there is a direct relationship between the amount of sulphate on the battery plates and the internal resistance of the battery. Thus if the internal resistance of the battery is much greater than the internal resistance of the voltage source, the voltage applied to the battery terminals is the full amplitude of the voltage source.

If the internal resistance of the battery is the same as the internal resistance of the voltage source, then the amplitude of the voltage is half the amplitude of the voltage source. Finally when the internal resistance of the battery is much less than the internal resistance of the voltage source the amplitude of the voltage at the battery terminals is minimal. In this way it can be seen that the internal resistance of the battery determines the amplitude of the voltage applied to the battery terminals. The lower the internal battery resistance the less the voltage applied to the battery terminals and the battery is therefore healthier.

The average current consumption of the apparatus 10 is approximately 20 mA when the pulse generator 11 is enabled.

The pulse generator 11 has a number of novel characteristics. These include the filter circuit comprising components C3, R7, L3 and C2. Thus the use of an LC filter overcomes problems associated with an RC filter which has much higher impedance to fast pulses and will not short outcoming pulses to the ground. This solution represents a much lower dynamic resistant during off period of the control circuit and high impedance for outcoming pulses. The LC circuit also negates the need of a Schottky diode which further maximises output voltage (energy). The Schottky diode or fast recovery diode represents a limiting resistance which actually lowers peak surge current (outcoming pulse energy).

In addition the output stage of the pulse generator incorporates a parallel inductor combination consisting of inductors L1 and L2 connected to the drain and polyswitch F1. The controller 12 is thus able to be connected to the inductors L1 and L2 at a coupling point before the polyswitch F1. This allows the controller to compare a preset threshold voltage value of the battery with a reference voltage level of the battery across diode D3. The selector switch S1 allows the threshold voltage value to be selected from one of two possible options. The operational amplifier IC1A therefore is able to switch on the pulse generator as long as the voltage measured across diode D3 is greater than the threshold voltage measured at terminal 5.

As previously mentioned, the controller 12 is operable to enable and disable the pulse generator 11. The controller 12 includes a comparator XC1a that compares the forward bias voltage of a 1N4148 diode D3 with a divided version of the battery voltage. A 6.8 kΩ resistor R6 and a parallel connected 0.1 μf capacitor C4 are connected between the supply voltage Vcc and the output of comparator IC1a. The output of comparator IC1a is connected to the second input of NAND-gate IC2c of the pulse generator 11. The −ve input of comparator IC1a is connected to the anode of diode D3 while the cathode of diode D3 is connected to the −ve terminal of the battery. A 1 μF capacitor C7 is connected in parallel to diode D3 and a 39 kΩ resistor R12 is connected to the anode of D3 and the supply voltage Vcc. A parallel connected 0.1 μF capacitor C3 and a 5.6 kΩ resistor R5 are coupled, to the +ve input of comparator IC1a and the −ve battery terminal. A 100 kΩ resistor R3 and parallel connected resistors R4 (130 kΩ) and R13 (6.8 MΩ) are also coupled to the +ve terminal of the comparator IC1a. Resistors R3, R4 and R R13 are coupled to the polyswitch F1 by a switch S1.

Resistors R3, R4, R13, R5 and switch S1 form a voltage divider network that is operable to divide the battery voltage in either one of two ways depending upon the position of the user operable switch S1. The position of switch S1 depends upon whether a user wishes the controller 12 to enable the pulse generator 11 when the battery voltage exceeds a threshold voltage of 10 V or 12.8 V. If the battery voltage is lower than the selected threshold voltage, the output of comparator IC1a is low which disables NAND gate IC2c and, hence, the pulse generator 11 since the square wave produced by the square wave generator is not passed to the transistor Q1. The current consumption of the apparatus 10 decreases to approximately 2 mA when the pulse generator 11 is disabled. If the battery voltage increases above the selected threshold voltage, the output of comparator IC1a goes high which enables NAND gate IC2c and, hence, the pulse generator 11 since the square wave produced by the square wave generator is passed to transistor Q1.

If a battery conditioning apparatus in accordance with the present invention is made for a typical 12 volt lead acid battery the threshold voltages are calculated based on battery manufacturers data. Thus one threshold is based on data relating to depth of discharge for engine start applications and auxiliary applications. In addition data is used relating to state of charge of lead acid batteries based on a single 2 volt cell.

In both cases the activation voltages are set at approximately 5% below the minimum values of the relevant data. Therefore the activation voltages for a 12 volt battery are 10 volts and 12.5 volts and for all other voltage models it is preferably a multiple of these values.

It can be seen from the above that the apparatus allows for switching between high and low voltage thresholds largely dependent upon the application of the battery. Thus a high voltage threshold would be selected for a car battery where the battery voltage preferably never goes below 5% of the minimum voltage level. This is in contrast to an application where the battery is used as a battery pack for running devices such as refrigerators, lights and other equipment. In such a situation the battery level may drop well below the 5% level before the battery is recharged. In contrast in a car battery the battery is continually recharged whenever the car is in operation.

The pulse amplitude indicator 13 is operable to indicate the amplitude of the pulses that are input into the battery by the pulse generator 11. The pulse amplitude indicator 13 includes three comparators Ic1b-d and other associated circuitry. The associated circuitry includes three light emitting diodes LED2-4 which are coupled to the outputs of the comparators IC1b-d. In particular, LED2, which is green, is coupled to the output of comparator IC1b via a 1N4148 diode D2. LED3 is yellow and is coupled to the output of comparator IC1c, while LED4, which is red, is coupled to the output of comparator IC1d. The anodes of LED2-4 are coupled to the +ve battery terminal via a 2.2 kΩ resistor R8. The +ve input of each comparator IC 1b-d is coupled to the anode of diode D3. The −ve input of comparator IC1b is coupled to the +ve input of comparator IC1a of the controller 12. The −ve input of comparator IC1c is coupled to the +ve battery terminal via a 820 kΩ resistor R9 and a 1N4148 diode D4. The −ve input of comparator IC 1c is also coupled to the −ve battery terminal via resistor R9 and a 0.1 If capacitor C6. A 10 kΩ resistor R10 interconnects the −ve inputs of comparators IC1c and IC1d. The −ve input of comparator IC1d is also coupled to the −ve battery terminal via a 20 kΩ resistor R11.

The operation of the pulse amplitude indicator 13 is such that LED2 is illuminated while the apparatus 10 is operating and the amplitude of the pulse produced by the apparatus 10 is less than approximately 20 V. LED3 illuminates if the pulse produced by the apparatus 10 is above 20 V. Since LED3 has a lower voltage drop compared to LED2 owing to diode D2 being connected in series with LED2, LED3 and LED2 cannot be illuminated simultaneously. LED4 illuminates if the pulse produced by the apparatus 10 is higher than 30 V. LED3 and LED4 cannot be illuminated simultaneously since LED4 has a lower voltage drop compared to LED3.

As the green LED 2 is associated with a low amplitude pulse being applied across the battery terminals it is also an indication of the internal resistance of the battery and therefore the health of the battery. Other embodiments are therefore envisaged in which additional LED's are provided showing a more gradual change in the voltage applied across the battery terminals and thus the health of the battery.

It is also envisaged to produce the indicator circuit 13 as a separate device or integrated circuit.

The device could also be connected to a microprocessor which would give a read out of the health of the battery.

According to one embodiment of the present invention a separate integrated circuit chip is provided for indicating the health of the battery and IC1A is provided by a different integrated circuit outside of the indicator circuit 13.

The apparatus 10 is also suitable for use with 24 V batteries. When used with a 24 V battery the threshold voltages of the controller are 21 V and 25.6 V, respectively.

The foregoing describes only one embodiment of the present invention and modifications, obvious to those skilled in the art, can be made thereto without departing from the scope of the present invention. For example, the apparatus 10 can be readily modified for use with batteries other than 12 V or 24 V batteries. If the apparatus 10 was to be modified for use with 4 V or 6 V batteries, additional circuitry would be required to convert these low voltages to the 12-18 V required by the zener diode D5 to produce the 10 V supply voltage Vcc.

1. An apparatus for lowering internal battery resistance, comprising a pulse generator for delivering pulses to at least one terminal of the battery and a controller for controlling the pulse generator and comprising a voltage input selector for selecting the voltage at which the controller is operated.

2. The apparatus as claimed in claim 1 wherein the voltage input selector comprises at least two threshold voltages at which the controller operates.

3. The apparatus as claimed in claim 1 wherein the voltage input selector comprises a high voltage threshold and a low voltage threshold.

4. The apparatus as claimed in claim 1 wherein the voltage input selector comprises a switch coupled to a voltage divider.

5. The apparatus as claimed in claim 4 wherein the controller has an input connected to the output of the pulse generator.

6. The apparatus as claimed in claim 5 wherein the controller has an output connected to an input stage of the pulse generator.

7. The apparatus as claimed in claim 6 wherein the controller includes a comparator for comparing the threshold of the voltage input selector with a reference voltage.

8. The apparatus as claimed in claim 7 wherein the reference voltage is derived from the battery.

9. The apparatus as claimed in claim 8 wherein the comparator outputs a signal to the output of the threshold voltage is above the reference voltage.

10. The apparatus as claimed in claim 9 wherein the pulse generator comprises an input stage including a wave generator for generating a wave having a predetermined frequency and wave width.

11. The apparatus as claimed in claim 10 wherein the wave generator comprises a square wave generator.

12. The apparatus as claimed in claim 11 wherein the pulse generator includes an input switch controlled by the controller.

13. The apparatus as claimed in claim 12 wherein the output switch comprises a transistor.

14. The apparatus as claimed in claim 1 wherein the controller is configured to vary the amplitude of pulses delivered to the battery in accordance with the internal resistance of the battery.

15. The apparatus as claimed in claim 14 including a battery condition circuit for indicating the amplitude of predetermined pulses delivered to the battery.

16. An electronic circuit for indicating a battery condition, comprising an indicator means, a first input for connection to a battery, a second input for connection to an output of a controller of a pulse generator wherein the indicator means provides an indication of the voltage of a pulse applied to the battery.

17. The electronic circuit as claimed in claim 16 wherein the indicator means provides an indication that the voltage of a pulse applied to a battery has one of a plurality of possible amplitudes.

18. The electronic circuit as claimed in claim 17 wherein the indicator means includes three different indicators.

19. The apparatus as claimed in claim 18 wherein the indicator means comprises three LEDs each connected to an output stage of an associated operational amplifier.

20. The electronic circuit as claimed in claim 19 wherein an input of each of the operational amplifiers is connected to a reference voltage source.

21. An apparatus for lowering battery internal resistance, comprising a wave generator, a filter circuit, a switch and an inductor means wherein the switch is configured to be switched on in accordance with the signal generated by the wave generator and in combination with the inductor means is configured to generate a periodic pulse which can be applied to a terminal of a battery, whereby the internal resistance of the battery is lowered.

22. The apparatus as claimed in claim 21 wherein the inductor means is connected to an output of the switch and to an output of the filter.

23. The apparatus as claimed in claim 21 wherein both the switch and inductor means are connected to one terminal of the battery.

24. The apparatus as claimed in claim 23 including a pulse width selector for altering the width of the pulse generated by the apparatus.

25. The apparatus as claimed in claim 21 including a pulse frequency selector for adjusting the frequency of the pulse generated by the apparatus.

26. The apparatus as claimed in claim 21 wherein the inductor means comprises two inductors in parallel.

27. The apparatus as claimed in claim 26 including a controller for selectively controlling operation of the apparatus in accordance with a threshold voltage setting.

28. The apparatus as claimed in claim 27 wherein an input of the controller is connected to the inductor means and the switch.

29. The apparatus as claimed in claim 21 including a controller for selectively controlling operation of the apparatus depending on a threshold voltage setting of the controller and a battery internal resistance indicator for providing a visual indication of at least two different internal resistance values for the battery.
